(19) United States
(12) Patent Application Publication
(10) Pub. No.: US 2025/0246107 A1
(43) Pub. Date: Jul. 31, 2025

(54) Display Device

(71) Applicant: APPLE INC., Cupertino, CA (US)

(72) Inventors: Danny L. McBroom, Leander, TX (US); Michael D. McBroom, Leander, TX (US); Rodrigo Dutervil Mubarak, Austin, TX (US); Stephen B. Lynch, Portola Valley, CA (US)

(21) Appl. No.: 19/014,397

(22) Filed: Jan. 9, 2025

Related U.S. Application Data
(60) Provisional application No. 63/627,395, filed on Jan. 31, 2024.

(51) Int. Cl. G09G 3/00; G06F 1/16; G06F 3/01

(52) U.S. Cl. CPC G09G 3/035; G06F 1/1652; G06F 3/013; G09G 2300/026; G09G 2340/0464; G09G 2354/00

(57) ABSTRACT

A display device includes a flexible display screen and one or more actuators. The one or more actuators are configured to induce bending of the flexible display screen in a first direction to move the flexible display screen between a first configuration and a second configuration, wherein the flexible display screen is one of flat or concave in the first direction in the first configuration, and the flexible display screen is convex in the first direction in the second configuration. The one or more actuators are activatable to move the flexible display screen between the first configuration and the second configuration by one of a sensor output from one or more sensors, a request from a software application, or a command from a subject.

### CROSS-REFERENCE TO RELATED APPLICATION

This application claims the benefit of, and priority to, U.S. Provisional Application No. 63/627,395, filed on Jan. 31, 2024, the contents of which are hereby incorporated by reference herein for all purposes.

### FIELD

The present disclosure relates generally to the field of display devices.

### BACKGROUND

Display devices, such display screens are incorporated in devices to display content to users. As examples, text, still images, and video images may be presented on a display screen. Some display screens are large to allow for comfortable viewing. To allow for convenient storage when not in use, folding display screens have been proposed.

### SUMMARY

A first aspect of the disclosure is a display device. The display device includes a flexible display screen. The display device also includes one or more actuators configured to induce bending of the flexible display screen in a first direction to move the flexible display screen between a first configuration and a second configuration. The flexible display screen is one of flat or concave in the first direction in the first configuration, and the flexible display screen is convex in the first direction in the second configuration. The display device also includes one or more sensors configured to identify a location of a subject relative to the flexible display screen. The display device also includes one or more processors configured to determine a content location along the first direction of the flexible display screen according to the location of the subject relative to the flexible display screen, and to display a content item on the flexible display screen according to the content location. The content location is determined such that the content item is viewable from the location of the subject when the content item is displayed according to the content location.

A second aspect of the disclosure is a display device. The display device includes a display screen. The display device also includes one or more actuators configured to move the display screen between a stored configuration and a deployed configuration. The display device also includes one or more sensors configured to identify a location of a subject and a gaze direction of the subject relative to the display screen. The display device also includes one or more processors configured to determine whether one or more transition conditions are satisfied based on the location of the subject and the gaze direction of the subject, and configured to control the one or more actuators to move the display screen between the stored configuration and deployed configuration in response to a determination that the one or more transition conditions are satisfied.

A third aspect of the disclosure is a display device. The display device includes a base structure having an external geometric configuration. The display device also includes a display screen. The display device also includes one or more actuators configured to induce movement of the display screen between a stored configuration and a deployed configuration. The display screen conforms to the external geometric configuration of the base structure when the display screen is in the stored configuration. At least part of the display screen is spaced from the base structure in the deployed configuration.

A fourth aspect of the disclosure is a display device. The display device includes a display screen and one or more actuators configured to move the display screen between a stored configuration and a deployed configuration. The display device also includes a first sensor configured to sense a subject in proximity of the display screen, the first sensor having a first resolution, and a second sensor configured to sense the subject in proximity of the display screen, the second sensor having a second resolution, wherein the second resolution is higher than the first resolution. The display device also includes one or more processors configured to control the one or more actuators to move the display screen between the stored configuration and deployed configuration in response to a determination that the subject is sensed by the first sensor, and display a content item based on sensing of the subject by the second sensor.

### BRIEF DESCRIPTION OF THE DRAWINGS

FIG. 1A is a front view illustration of a display device in a deployed configuration.

FIG. 1B is a top view illustration of the display device in the deployed configuration.

FIG. 1C is a top view illustration of the display device in the stored configuration.

FIG. 1D is a top view illustration of the display device in the stored configuration according to an alternative implementation.

FIG. 2A is a front view illustration of a display device in a deployed configuration.

FIG. 2B is a top view illustration of the display device in the deployed configuration.

FIG. 2C is a top view illustration of the display device in the stored configuration.

FIG. 3 is a block diagram of a process for operation of the display device.

FIG. 4 is a block diagram of a process for operation of the display device.

FIG. 5 is a block diagram of a process for operation of the display device.

FIG. 6 is a block diagram of a process for operation of the display device.

### DETAILED DESCRIPTION

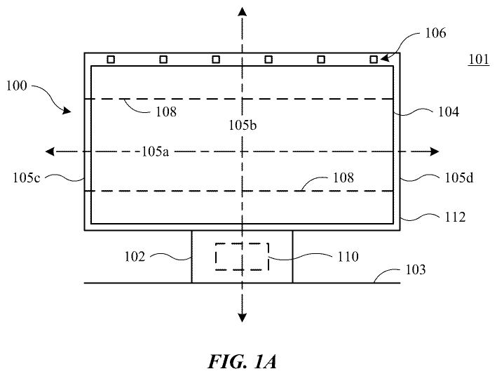

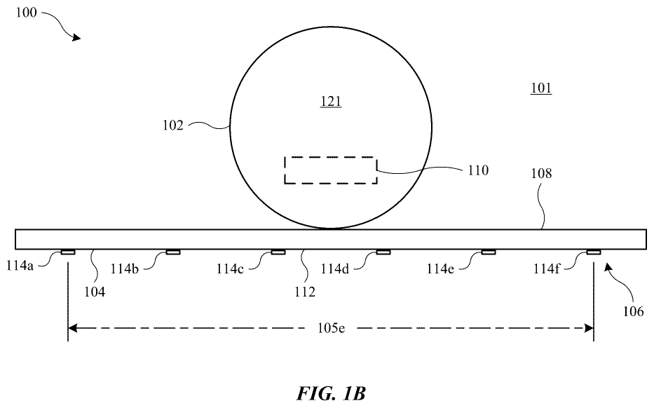

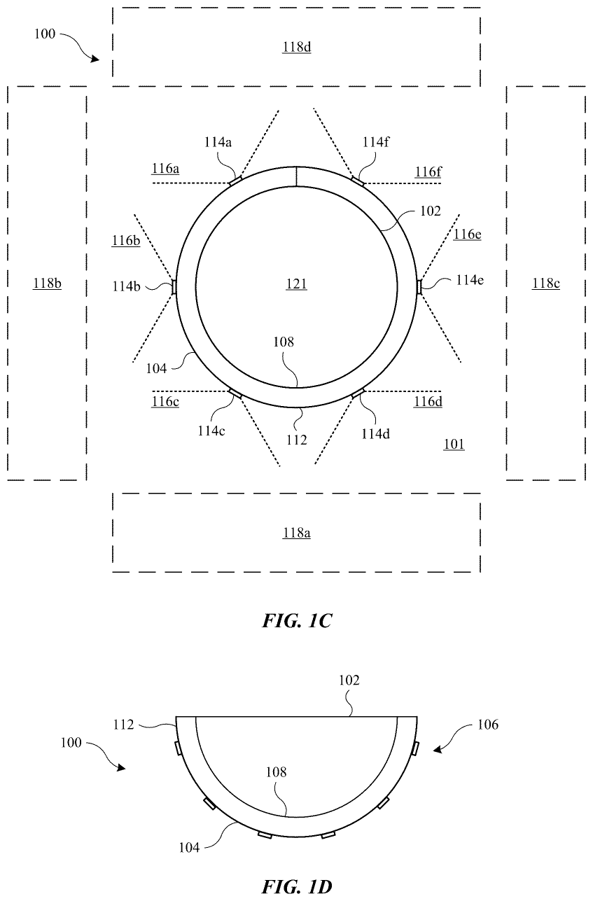

FIG. 1A is a front view illustration diagram of a display device 100 in a deployed configuration. FIG. 1B is a top view illustration of the display device 100 in the deployed configuration, and FIG. 1C is a top view illustration of the display device 100 in the stored configuration. FIG. 1D is a top view illustration of an alternative implementation of the display device 100 in the stored configuration.

The display device 100 includes a base 102 and a display screen, such as a flexible display screen 104 in the illustrated implementation. The display device 100 may include one or more sensors that are configured to perceive an environment 101 around the display device 100, such as sensors 106. The display device 100 may include one or more actuators that are configured to move the flexible display screen 104 or portions of the flexible display screen 104, such as actuators 108. The display device 100 may include one or more processors that are configured to control operation of the display device 100, such as processors 110.

The base 102 is a structure that is configured to support the flexible display screen 104. Thus, the flexible display screen 104 may be coupled to the base 102. In some implementations, the base 102 supports the flexible display screen 104 above a subjacent surface 103, such as a table surface or a floor surface, by engagement of the base 102 with the subjacent surface 103 such that the base 102 extends upward therefrom. The base 102 may be a static structure comprised of rigid materials such as metals, plastics, or composites, in order to provide a suitable mounting structure upon which the flexible display screen 104 can be supported. In some implementations, the base 102 is a static structure without moving components. In other implementations, the base 102 may include relatively movable components that allow for adjustment of the base 102, for example, to change a height of the flexible display screen 104 relative to the subjacent surface 103. Such relatively movable components may allow for manual adjustment of the position of the flexible display screen 104, or may be actuated to allow for automated adjustment of the position of the flexible display screen 104.

The flexible display screen 104 is a visual output device capable of displaying content that can be viewed by a subject. The content that is displayed by the flexible display screen 104 may be graphical content, such as still images, videos, text, and combinations thereof. The flexible display screen 104 can be implemented using technologies including, but not limited to, liquid crystal displays (LCDs), light-emitting diodes (LED) panels, and organic light-emitting diode (OLED) panels. The flexible display screen 104 is configured to bend, thereby allowing changes to the physical configuration of the flexible display screen 104. Bending of the flexible display screen 104 includes movement of at least a portion of the flexible display screen 104 with respect to the base 102, while the base 102 remains at a fixed position. To allow bending, the flexible display screen 104 may include a flexible substrate on which light emitting display elements (e.g., light-emitting diodes or other light-emitting elements) are located.

The flexible display screen 104 is moveable between a first configuration and a second configuration. The first configuration is a deployed configuration, and the second configuration is a stored configuration. The deployed configuration is intended to be utilized during normal operation of the display device 100, when the display device 100 is in active use by a subject (e.g., a user or other person dear the display device 100), such as when the subject's primary activity is viewing content that is presented by the display device 100. In the deployed configuration, the flexible display screen 104 is expanded in width and visual presence, and may be configured to allow viewing of an entirety of the flexible display screen 104 from a single viewing location. In the stored configuration, the spatial footprint of the flexible display screen 104 is compacted, such as by bending or folding, which may reduce the amount of space occupied by the flexible display screen 104, or may reduce the visual presence of the flexible display screen 104 in the environment 101. The flexible display screen 104 may be transitioned between the stored configuration and the deployed configuration by operation of the actuators 108, under control of the processors 110, as will be described further herein.

In some implementations, a geometric configuration of the flexible display screen 104 may be complementary to an external geometric configuration of the base 102 when the flexible display screen 104 is in the stored configuration. The external geometric configuration of the base 102 may be, for example, a cylindrical external geometric configuration as in the implementation of FIGS. 1A-1C, a semi-cylindrical external geometric configuration as in the implementation of FIG. 1D, a polygonal configuration, or another external geometric configuration. In some implementations, when the flexible display screen 104 is in the stored configuration, the flexible display screen 104 conforms to the external geometric configuration of the base 102. As an example, in an implementation in which the base 102 has a cylindrical configuration, the flexible display screen 104 may be disposed in a cylindrical configuration when stored, or may confirm to the cylindrical configuration of the base 102 by extending circumferentially around a portion the exterior of the base 102, such as 50 percent, 75 percent, or more of the circumference of the cylindrical configuration of the base 102. In the deployed configuration, at least part of the flexible display screen 104 is spaced from the base 102, such that portions of the flexible display screen 104 are farther from the exterior of the base 102 in the deployed configuration as compared to the stored configuration.

In implementations in which the flexible display screen 104 conforms to the external geometric configuration of the base 102 in the stored configuration, the display device 100 may also include a fixed display screen 121 that is coupled to the base 102, wherein the flexible display screen 104 and the fixed display screen 121 are controllable to display a continuous image when the flexible display screen 104 is in the stored configuration, such as by provision of a first image portion to the flexible display screen 104 and provision of a second image portion to the fixed display screen 121, the first and second image portions together defining the continuous image. The fixed display screen 121 may be located on a top surface of the base 102 and the flexible display screen 104 is located adjacent to one or more side surfaces of the base 102 when the flexible display screen 104 is in the stored configuration.

Movement of the flexible display screen 104 between the deployed configuration and the stored configuration may include bending of the flexible display screen 104 in a first direction 105a. As an example, the first direction 105a may be a width direction or side-to-side direction relative to the flexible display screen 104, as it is viewed by the subject. Thus, bending in the first direction 105a may correspond to bending of the flexible display screen 104 around a bending axis that extends in a second direction 105b that is orthogonal to the first direction 105a. The second direction 105b may be an elevational direction or height direction relative to the flexible display screen 104 as it is viewed by the subject.

In implementations that including movement of the flexible display screen 104 between the deployed configuration and the stored configuration by bending in the first direction 105a, the display screen 104 may be one of flat or concave (e.g., defining a radius of one meter or greater) in the deployed configuration to allow viewing of an entirety of the flexible display screen 104 by a subject from a single viewing location. The flexible display screen 104 screen may be convex in the stored configuration, with the light-emitting display elements of the flexible display screen 104 facing outward relative to the bending axis. In some implementations, the flexible display screen 104 is generally cylindrical in the stored configuration, as seen in FIG. 1C. In some implementations, the flexible display screen 104 is defines an arcuate shape that is less than a full cylinder, such as a semi-cylinder as seen in FIG. 1D, or an arcuate configuration having a complex curvature (e.g., a non-constant radius).

The display device 100 may include a bezel 112 that extends along one or more sides of the flexible display screen 104. In the illustrated implementation, the bezel 112 is located at and extends around an outer periphery of the flexible display screen 104 such that the bezel 112 surrounds the flexible display screen 104 as seen from a viewing direction of the flexible display screen 104. The bezel 112 is flexible so that it is able to bend with the flexible display screen 104 as the flexible display screen 104 moves between the stored configuration and the deployed configured. As example, the bezel 112 may be thin in the front-to-rear direction of the flexible display screen 104 to facilitate bending, and may be formed from a flexible material such as flexible plastics, metals, or combinations thereof.

The sensors 106 (e.g., one or more sensors) are configured to generate sensor outputs (e.g., sensor output signal) that represent observations of the environment 101. The sensors 106 are configured to output information that is usable by the processors 110 to identify a location of a subject relative to the flexible display screen 104. The information output by the sensors 106 may further be utilized to identify objects in the environment 101 around the flexible display screen 104, such as by identifying the types of the objects and the locations of the objects.

The sensors 106 may be coupled to the base 102, to the flexible display screen 104, and/or to another portion of the display device 100. As an example the sensors 106 may generated sensor outputs such as visible spectrum images, infrared images, depth images, range information, three-dimensional point clouds, and/or other types of information dependent upon the types of sensing elements that are included in the sensors 106. Various types of sensing devices may be included in the sensors 106. As examples, the sensors 106 may include digital still cameras, digital video cameras, infrared imagers, depth cameras, lidar modules such as scanning lidar modules and/or flash lidar modules, ultrasonic sensors for distance measuring, capacitive sensors, microphones, and/or other types of sensors. As will be explained herein, the sensors 106 may be configured to obtain information that is usable to understand the environment 101, and to understand the presence, location, and/or motion of objects or persons in the environment 101.

The sensors 106 are intended to allow observations of the environment 101 when the flexible display screen 104 is in the deployed configuration and when the flexible display screen 104 is in the stored configuration. In some implementations, this is achieved by coupling the sensors 106 to the display device 100 such that the sensors 106 move with the flexible display screen 104 between the deployed configuration and the stored configuration. As one example, the sensors 106 may be connected to the flexible display screen 104 and move with the flexible display screen 104 between the stored configuration and the deployed configuration. As another example, the sensors 106 may be connected to a portion of the display device 100 that moves in unison with the flexible display screen 104. In alternative implementations, the sensors 106 are connected to the display device 100 such that the sensors 106 do not move with the flexible display screen 104 and instead stay in a fixed position during movement between the deployed configuration and the stored configuration, such as by coupling the sensors 106 to the base 102 at a location that is above or below the flexible display screen 104 in the second direction 105b.

The sensors 106 may include multiple individual sensors or groups of sensors that are spaced from one another in the first direction 105a. The sensors 106 may be spaced with respect to one another to allow for good sensor coverage of the of the environment 101, and also to define overlapping fields of view both in the stored configuration and the deployed configuration. As an example, the field of view of each of the sensors 106 may overlap with the field of view of one or two adjacent ones of the sensors 106. The number of the sensors 106 that are included may be a function of the size of the flexible display screen 104 as well as the angular size of a field of view of each of the sensors 106 (e.g., a one-hundred twenty degree field of view in the illustrated example). As an example, the sensors 106 include a first sensor 114a having a first field of view 116a, a second sensor 114b having a second field of view 116b, a third sensor 114c having a third field of view 116c, a fourth sensor 114d having a fourth field of view 116d, a fifth sensor 114e having a fifth field of view 116e, and a sixth sensor 114f having a sixth field of view 116f, as best seen in FIGS. 1B-1C.

The fields of view of the sensors 106 may be arranged to permit observation of one of more predefined zones of the environment 101 that are used for detection purposes, such as a first zone 118a, a second zone 118b, a third zone 118c, and a fourth zone 118d. The locations and spatial extents of these zones may be determined prior to determining a location of the subject with respect to the display device 100, and therefore, the zones of the environment 101 may be referred to as predefined environment zones. The processors 110 may be configured to control operation of the display device 100 dependent upon whether the subject is present in one of the predefined environment zones. As an example, the processors 110 may be configured to perform an action if the subject is present in a first predefined environment zone, and the processors 110 may be configured to forgo performance of the action if the subject is present in a second predefined environment zone that is distinct from the first predefined environment zone.

In this example, the sensors 106 are arranged to define a three-hundred and sixty degree sensor field of view around the display device 100. As seen in this implementation, the sensors 106 may be distributed across a significant portion of the width of the flexible display screen 104, where the width of the flexible display screen 104 is defined between a first end 105c and a second end 105d of the flexible display screen 104 that are spaced from one another in the first direction 105a. Thus, and a first pair of the sensors 106, such as the first sensor 114a and the sixth sensor 114f, is spaced apart along the display device 100 by a distance 105e equal to or greater than twenty-five percent, fifty percent, seventy-five percent or more of the width of the flexible display screen 104.

To allow spacing of the sensors 106 in the first direction 105a, the sensors 106 may be arranged in an array along the bezel 112 of the flexible display screen 104. For example, the sensors 106 may be coupled to a portion of the bezel 112 in that extends in the width direction of the flexible display screen 104. The sensors 106 may be coupled to a portion of the bezel 112 that is located above the flexible display screen 104, below the flexible display screen 104, or both above and below the flexible display screen 104 (e.g., defining two linear arrays of the sensors 106). Other configurations may be used.

As an alternative to locating the sensors 106 on the bezel 112 of the display device 100, the sensors 106 may be located behind the flexible display screen 104. As an example, apertures (e.g., generally transparent portions free from light-emitting display elements) may be defined in the flexible display screen 104, and the sensors 106 may be positioned behind the apertures to view the environment 101 through the apertures.

The actuators 108 (e.g., one or more actuators) are configured to move the flexible display screen 104 between the stored configuration and the deployed configuration. In particular, the actuators 108 are configured to induce bending of the flexible display screen 104 in the first direction 105a to move it between the stored configuration and the deployed configuration. The actuators 108 are operably connected to the flexible display screen 104, and in some implementations, may further be coupled to the base 102 and/or to another portion of the display device 100. The actuators 108 are activatable, under control by the processors 110, to move the flexible display screen 104 between the deployed configuration and the stored configuration by one of a sensor output from the sensors 106, a request from a software application, or a command from the subject.

In some implementations, the actuators 108 include a linkage (e.g., comprising one or more links) driven by a prime mover to cause movement of the flexible display screen 104 between the deployed configuration and the stored configuration by bending of the flexible display screen 104 in the first direction 105a. As an example, a linkage may include links that are connected to one another by pivot joints, sliding joints, telescoping joints, and/or other joints to cause movement of the flexible display screen 104 in a predetermined manner in response to operation of an electric motor or other prime mover, such as by rotation of one or more of the links in response to rotation of the electric motor.

In some implementations, the actuators 108 include a flexible beam that is urged by a biasing force toward a neutral position by a spring-like behavior (e.g., using a spring steel panel) to move the flexible display screen 104 to the deployed configuration. In this implementation, the actuators 108 may include a retractor (e.g., a cable system extended and retracted by an electric motor) that is configured to retract the flexible beam toward the base 102 by bending of the flexible beam and the flexible display screen 104 together in the first direction 105a in order to move the flexible display screen 104 from the deployed configuration to the stored configuration. When the retractor is relaxed, the biasing force of the flexible beam causes the flexible beam to move the flexible display screen 104 back to the deployed configuration.

In some implementations, the actuators 108 are shape memory alloy actuators. Shape memory alloy actuators can be utilized to induce bending of the flexible display screen 104 in the first direction 105a. These actuators are made of an alloy that can move from a current shape to an original shape when heated. This allows shape memory alloy actuators to be used as the actuators 108 to bend the flexible display screen 104 in the first direction 105a to transition the flexible display screen 104 between the stored configuration and the deployed configuration. The shape memory alloy actuators may be operably connected to the flexible display screen 104. Shape memory alloy actuators can be made of a variety of materials, including Nitinol. Nitinol is a nickel-titanium alloy that is known for its shape memory properties. It is useful for shape memory alloy actuators due to its ability to remember its original shape and return to it when heated. This allows the Nitinol actuators to bend the flexible display screen 104 in the first direction, for example, to move the flexible display screen 104 from the stored configuration to the deployed configuration, and then return to the original shape when cooled, for example, to move the flexible display screen 104 from the deployed configuration to the stored configuration.

In some implementations, the actuators 108 are bimetallic actuators. Bimetallic actuators are a type of actuator that can be used to induce bending of the flexible display screen 104 in the first direction 105a. Bimetallic actuators may be made by bonding two different metals together, such as nickel and titanium, for example, in a strip. The two metals are chosen for their different thermal expansion properties, such that, when the strip is heated, the two metals expand at different rates, causing the strip to bend. This bending can be used to move the flexible display screen 104 between a stored and deployed configuration by coupling the actuators 108, implemented as bimetallic actuators, to the flexible display screen 104, extending in the first direction 105a.

The processors 110 (e.g., one or more processors) are computing devices that are configured to control operation of the display device 100, such as by executing program instructions that are configured to cause the processors to perform operations that implement the various functionalities of the display device 100. Operations performed by the processors 110 include, but are not limited to, processing signals and/or data, making determination based on such signals and/or data, obtaining and interpreting user inputs, and the generation of content that is output to the flexible display screen 104. The processors 110 may be implemented utilizing various technologies, such as Application-Specific Integrated Circuits (ASICs), Field-Programmable Gate Arrays (FPGAs), or standard microprocessor units found in embedded systems. The processors 110 may incorporate, or be provided with access to, complementary hardware devices such as memory devices, non-volatile storage devices, and input/output devices.

The processors 110 may be operable to store, load, and execute computer program instructions. As an example, the processors may load computer program instructions from a non-volatile storage device, and may store the computer program instructions in memory. When executed by the processors 110, the computer program instructions cause the processors 110 to perform operations. The operations that can be performed by the processors 110 may include obtaining information. Examples of obtaining information include accessing the information from a storage device, accessing the information from short-term memory, receiving a wired or wireless transmission that includes the information, receiving signals from an input device that represent user inputs, and receiving signals from the sensors 106 that represent observations made by the sensors 106. The operations that can be performed by the processors 110 may include making a determination. Examples of making a determination include comparing a value to a threshold, comparing states to conditions, and making a calculation using data of any type. The operations that can be performed by processors 110 may also include transmitting information, for example, to a remote system. The operations that can be performed by the processors 110 may also include outputting a signal to cause an external device to perform an operation. As examples, the processors 110 may control a component, cause a sensor to take a measurement, cause a camera to capture an image, or cause operation of an actuator in a specified manner.

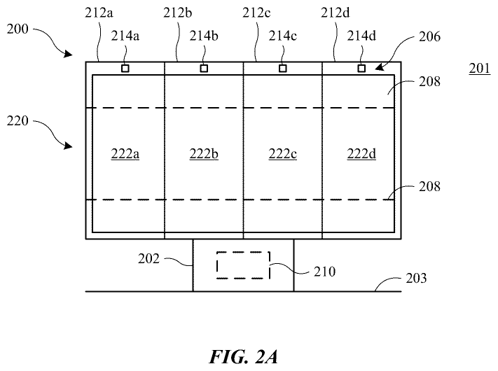

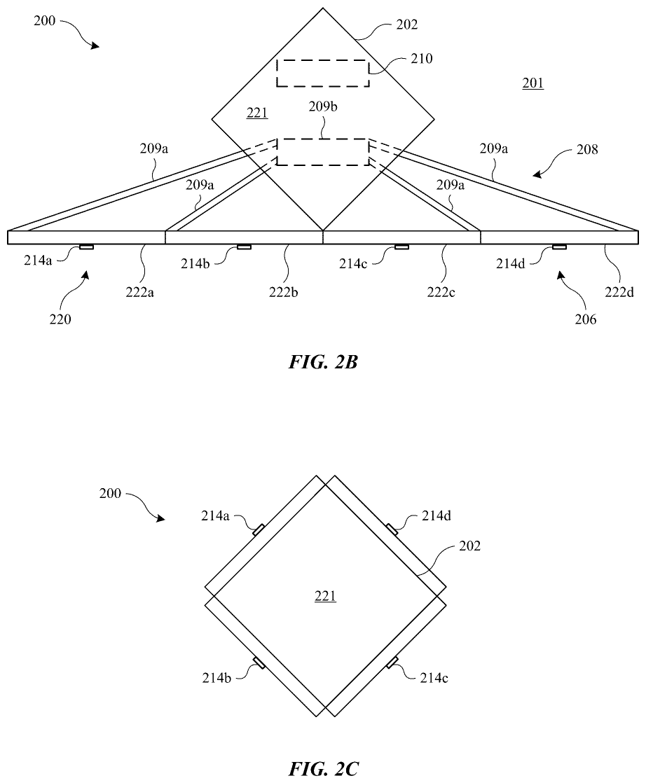

FIG. 2A is a front view illustration diagram of a display device 200 in a deployed configuration. FIG. 2B is a top view illustration of the display device 200 in the deployed configuration, and FIG. 2C is a top view illustration of the display device 200 in the stored configuration.

The display device 200 includes a base 202 and a display screen 220. The base 202 is equivalent to the base 102 of the display device 100 except as described to the contrary, and is configured to support the display screen 220 above a subjacent surface 203. The display device 200 may include sensors 206, actuators 208, and processors 210 that are equivalent to the sensors 106, actuators 108, and processors 110 of the display device 100 except as described to the contrary herein.

The display screen 220 is a visual output device capable of displaying content that can be viewed by a subject, and is equivalent to the flexible display screen 104 except as described to the contrary. Instead of being flexible to allow movement between the stored configuration and the deployed configuration, the display screen 220 includes two or more rigid panels that are configured to move relative to each other, such as a first panel 222a, a second panel 222b, a third panel 222c, and a fourth panel 222d in the illustrated implementation, and which may be referred to herein as panels 222a-222d. Transitions of the display device 200 includes movement of the panels 222a-222d with respect to each other, as will be described herein. Each of the panels 222a-222d may be implemented using the display technologies described with respect to the flexible display screen 104, such as liquid crystal displays (LCDs), light-emitting diodes (LED) panels, and organic light-emitting diode (OLED) panels.

A geometric configuration of the display screen 220 may be complementary to an external geometric configuration of the base 202 when the display screen 220 is in the stored configuration. In the illustrated implementation, the external geometric configuration of the base 202 is that of a cuboid that is square as viewed from above. In the stored configuration a respective one of the panels 222a-222d may be located adjacent to a respective side of the cuboid configuration of the base 202, thereby confirming the geometric configuration of the panels 222a-222d to the external geometric configuration of the base 202. In the deployed configuration, one or more of the panels 222a-222d is spaced from the base 202, such that portions of the display screen 220 are farther from the exterior of the base 202 in the deployed configuration as compared to the stored configuration. For example, one or more of the panels 222a-222d may be pivoted away from the base 202 by the actuators 208 during movement from the stored configuration to the deployed configuration. Movement of the display screen 220 between the deployed configuration and the stored configuration may include pivoting of one of more of the panels 222a-222d. Pivoting of the panels 222a-222d may include pivoting around an axis that extends in an elevational direction or height direction relative to the display screen 220 as it is viewed by the subject. In some implementations, the panels 222a-222d may be coplanar with respect to each other in the deployed configuration, and may extend at non-zero angles (e.g., greater than five degrees) with respect to each other in the stored configuration. Although the panels 222a-222d include four panels and define a four-sided configuration in the illustrated implementation, other configurations such as two-sided, three-sided or greater than four-sided are possible.

In implementations in which the display screen 220 conforms to the external geometric configuration of the base 202 in the stored configuration, the display device 200 may also include a fixed display screen 221 that is coupled to the base 202, wherein the display screen 220 and the fixed display screen 221 are controllable to display a continuous image when the display screen 220 is in the stored configuration, such as by provision of a first image portion to the display screen 220 and provision of a second image portion to the fixed display screen 221, the first and second image portions together defining the continuous image. The fixed display screen 221 may be located on a top surface of the base 202 and the display screen is located adjacent to one or more side surfaces of the base 202 when the display screen 220 is in the stored configuration.

The sensors 206 (e.g., one or more sensors) are configured to generate sensor outputs (e.g., sensor output signal) that represent observations of the environment 201, and may be implemented using the same sensing technologies described with respect to the sensors 106.

The sensors 206 may include multiple individual sensors or groups of sensors that are spaced from one another in a width direction of the display screen 220 to allow observations of the environment 201 in the stored configuration and in the deployed configuration. In some implementations, one or more of the sensors 206 may be located on respective one of the panels 222a-222d, as a first sensor 214a on the first panel 222a, a second sensor 214b on the second panel 222b, a third sensor 214c on the third panel 222c, and a fourth sensor 214d on the fourth panel 222d. The arrangement spaces the sensors 206 in a width direction of the display screen 220. This sensor placement may be accommodated by locating the sensors 206 in a bezel defined by a first bezel portion 212a coupled to the first panel 222a, a second bezel portion 212b coupled to the second panel 222b, a third bezel portion 212c coupled to the third panel 222c, and a fourth bezel portion 212d coupled to the fourth panel 222d. As an alternative to locating the sensors 206 on the bezel of the display device 200, the sensors 206 may be located behind the display screen 220. As an alternative to locating the sensors 206 on the bezel of the display device 200, the sensors 206 may be located on the base 202 so that they do not move with the display screen 220.

The actuators 208 (e.g., one or more actuators) are configured to move the display screen 220 between the stored configuration and the deployed configuration. In particular, the actuators 208 are configured to configured to move the panels 222a-222d of the display screen 220, such as by causing pivoting the panels 222a-222d with respect to each other. The actuators 208 are operably connected to the panels 222a-222d of the display screen 220, and in some implementations, may further be coupled to the base 202 and/or to another portion of the display device 200. The actuators 208 are activatable, under control by the processors 210, to move the display screen 220 between the deployed configuration and the stored configuration by one of a sensor output from the sensors 206, a request from a software application, or a command from the subject.

In some implementations, the actuators 208 include linkages 209a (e.g., one or more linkages) driven by a prime mover, such as electric motors 209b (e.g., one or more electric motors). The linkages 209a and electric motors 209b may be configured to cause movement of the display screen 220 between the deployed configuration and the stored configuration by changing the angular orientations of the panels 222a-222d of the display screen 220. As an example, the linkages 209a may include links that are connected to one another by pivot joints, sliding joints, telescoping joints, and/or other joints to cause movement of the display screen 220 in a predetermined manner in response to operation of the electric motors 209b, such as by rotation of one or more of the links in response to rotation of the electric motors 209b. In some implementations, the panels 222a-222d may be connected to each other by spring biased joints that bias the display screen 220 to the deployed configuration. In this implementation, the actuators 208 may include a retractor (e.g., a cable system extended and retracted by an electric motor) that is configured to retract the rigid beam portion toward the base 202 by pivoting the beam portions with respect to each other.

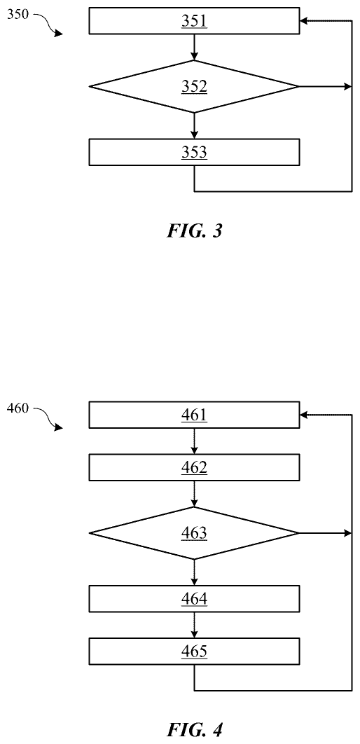

FIG. 3 is a block diagram of a process 350 for controlling operation of a display device by transitioning the display device between a stored configuration and a deployed configuration in response to explicit commands. The process 350 is described with reference to the display device 100. The process 350 may also be implemented using other types of display devices that are configured to move between stored and deployed configurations, including the display device 200. The process 350 may be implemented in the form of computer program instructions that are provided to processors, such as the processors 110 of the display device 100. When executed, the computer program instructions cause the processors 110 to control the display device 100 according to the operations of the process 350, as described herein. The instructions may be obtained by the processors 110 from a non-volatile storage device or may be obtained by the processors 110 in any other suitable manner.

The process 350 may be performed repeatedly, on an ongoing basis, in order to allow the flexible display screen 104 to be moved between the deployed configuration and the stored configuration in response to an explicit command. Operation 351 of the process 350 includes obtaining sensor outputs from the sensors 106. As examples, sensor outputs may be obtained using cameras, lidar modules, microphones, radio frequency receivers, infrared receivers, ultrasonic sensors, and/or other sensing devices that are included in the sensors 106.

Operation 352 includes determining whether an explicit command to transition between the stored configuration and the deployed configuration has been received. In particular, the actuators 108 are activatable to move the flexible display screen 104 between the stored configuration and the deployed configuration, and such activation may be controlled by an explicit command. Operation 352 may include determining whether the sensor outputs obtained in operation 351 include an explicit command to transition between the stored and deployed configurations. In response to determining that an explicit command to transition the flexible display screen 104 between the stored configuration and the deployed configuration has been received, the process 350 may advance to operation 353. Otherwise, the process 350 may return to operation 351.

An explicit command that can be utilized to trigger a transition between the stored configuration and the deployed configuration may be a request from a software application that is executed by the processors 110 of the display device 100. As an example of a request from software application as an explicit command to transition between the stored configuration and the deployed configuration, a scheduling application may output a command to move the flexible display screen 104 from the stored configuration to the deployed configuration at a first time of day (e.g., 1:00 PM) and may output a command to move the flexible display screen 104 from the deployed configuration to the stored configuration at a second time of day (e.g., 2:00 PM).

An explicit command that can be utilized to trigger a transition between the stored configuration and the deployed configuration may be a command from the subject that is received by the processors 110 using the sensors 106 or by other means. As an example of a command from the subject, the subject may utter a voice command that is captured by the sensors 106 (e.g., a microphone thereof), where the voice command requests one of a transition from the stored configuration to the deployed configuration or a transition from the deployed configuration to the stored configuration. As another example of a command from the subject, the subject may operate a button or other control device (e.g., mounted on the display device 100 or included in a remote control or other device) that causes the processors 110 of the processors 110 to receive a command to transition the flexible display screen 104 between the stored configuration and the deployed configuration.

As another example of a command from the subject, the subject may make a gesture (e.g., a predetermined gesture) that is intended to command the display device 100 to transition between the stored and deployed configurations. The gesture may be, for example, a hand motion and/or arm motion that is recognized by the processors 110 as associated with a subject intention to transition the display device 100 between the deployed configuration and the stored configuration. For instance, an upward swiping motion made by the subject in front of the display device 100 may be interpreted as a signal to transition the display device 100 from the stored configuration to the deployed configuration, while a downward swipe may be interpreted as a signal to transition the display device 100 from the deployed configuration to the stored configuration.

In operation 353, the processors 110 controls the actuators 108 to transition the flexible display screen 104 between the stored configuration and the deployed configuration. In particular, the processors 110 may control the actuators 108 to induce bending of the flexible display screen in the first direction 105a to move the flexible display screen 104 between the deployed configuration and the stored configuration, wherein the flexible display screen 104 is one of flat or concave in the first direction 105a in the deployed configuration, and the flexible display screen 104 is convex in the first direction 105a in the stored configuration. Thus, when the flexible display screen 104 is in the stored configuration, the processors 110 may control the actuators 108 to cause the flexible display screen 104 to move from the stored configuration to the deployed configuration, and when the flexible display screen 104 is in the deployed configuration, the processors 110 may control the actuators 108 to cause the flexible display screen 104 to move from the deployed configuration to the stored configuration.

FIG. 4 is a block diagram of a process 460 for controlling operation of a display device 100 by determining whether to transition a display device between a stored configuration and a deployed configuration. The process 460 is described with reference to the display device 100. The process 460 may also be implemented using other types of display devices that are configured to move between stored and deployed configurations, including the display device 200. The process 460 may be implemented in the form of computer program instructions that are provided to the processors 110. When executed, the computer program instructions cause the processors 110 to control the display device 100 according to the operations of the process 460, as described herein. The instructions may be obtained by the processors 110 from a non-volatile storage device or may be obtained by the processors 110 in any other suitable manner. Details from the process 350 may be incorporated in or used with the process 460.

The process 460 may be performed repeatedly, on an ongoing basis, in order to allow the flexible display screen 104 to be moved between the deployed configuration and the stored configuration in an automated manner, based on conditions in the environment 101. In the illustrated implementation, the process 460 includes obtaining sensor outputs from the sensors 106 in operation 461, making one or more observations about the subject (e.g., the user of the display device 100) in operation 462, making one or more observations about the environment 101 by obtaining information from sensors in operation 463, determining whether to transition the flexible display screen 104 of the display device 100 between the stored configuration and the deployed configuration in operation 464, and in response to a determination to transition the configuration of the flexible display screen 104 of the display device 100, moving the flexible display screen 104 of the display device 100 between the stored configuration and the deployed configuration in operation 465.

In operation 461, the processors 110 obtain sensor outputs from the sensors 106. Operation 461 may include obtaining one or more images from one or more cameras that are included in the sensors 106. Operation 461 may include obtaining three-dimensional images (e.g., one or more depth images or information interpretable to define a point cloud) from a three-dimensional sensor such as a lidar module or a depth camera. Operation 461 may include obtaining other types of inputs from other sensors.

Operation 462 includes making one or more observations about the subject. The subject is a person in the environment 101 around the display device 100, and may be a user of the display device 100. The observations about the subject may be made using the sensors 106 of the display device 100 and may be processed and interpreted by the processors 110 of the display device 100. In some implementations, operation 462 may further include making one or more observations about two or more subjects who are near the display device 100.

Making one or more observations about the subject in operation 462 may include determining a location of the subject relative to the display device 100. The presence and location of one or more subjects may be determined using the information from the sensors 106 that was obtained in operation 461. In some situations, the processors 110 may determine that no subjects are present in the environment 101 within the sensing range of the sensors of the display device 100. In situations where one or more users are identified as presented in the environment 101, the location of each of the subjects can be determined to inform the deployment of display device 100.

The sensors 106 are configured to identify the location of the subject relative to the display device 100 and the flexible display screen 104 thereof by processing sensor outputs from the sensors 106 using the processors 110. As an example, the sensors 106 may generate outputs that represent the environment 101 as described with respect to operation 462. The sensor outputs that are generated by the sensors 106 are obtained by and processed by the processors 110, for example, by using machine vision techniques. As one example, an image classifier implemented using a trained neural network may be used to identify the presence and location of the subject relative to the flexible display device 104.

The sensor outputs from the sensors 106 may be processed by the processors 110 of the display device 100 to determine the two dimensional location or the three-dimensional location of the subject relative to the display device 100. Images, point clouds, and/or other sensor outputs can be processed to determine the location of a moving object within the field of view of the sensors 106 (e.g., cameras and/or lidar modules) by using techniques such as optical flow, feature tracking, and object detection. Optical flow is a technique that tracks the motion of pixels in an image over time, allowing the motion of objects to be determined. Feature tracking is a technique that tracks the movement of specific features, such as corners or edges, allowing the motion of objects to be determined. Object detection is a technique that uses machine learning algorithms to identify objects according to their visual appearance, allowing the location of the object to be determined. These techniques may be implemented using a trained machine learning model, such as a deep neural network, or in another suitable form, and by providing program instructions to the processors 110 that are configured to cause the processors 110 to process the outputs from the sensors 106 in the desired manner.

The lateral or angular position of the subject can be determined (e.g., estimated) based on the lateral position of the subject as identified in the sensor inputs. The distance of the subject from the display device 100 can be determined (e.g., estimated) by triangulation based on outputs from two or more of the sensors 106, by an apparent size of the subject in the sensor output, using a machine learning based approach, or using another suitable method.

The processors 110 may be configured to represent the location of the subject as a two-dimensional position relative to the display device 100 from a top-down perspective. As one example, the position of the subject may be represented in the form of cartesian coordinates (e.g., an X-coordinate and a Y-coordinate) relative to a datum point, which may be a feature of the display device 100, such as a lateral center point of the flexible display screen 104 of the display device 100. As another example, the position of the subject may be represented in polar coordinates, by determining an angle of a reference line between a datum point of the display device 100 (e.g., a bending axis of the flexible display screen 104), and by determining a distance between the datum point and the subject.

Making one or more observations about the subject in operation 463 may include determining a gaze direction of the subject relative to the flexible display screen 104 of the display device 100. The gaze direction represents the direction in which the subject's eyes are oriented, and allow the processors 110 to consider information representing what the subject is looking at when the processors 110 make control decisions about operation of the device. The gaze direction for the subject may be determined using the information from the sensors 106 that was obtained in operation 462. The gaze direction for the subjects may be detected over time in order to make decisions about operation of the display device 100.

The sensors 106 are configured to identify the gaze direction of the subject relative to the display device 100 and the flexible display screen 104 thereof by processing the sensor outputs from the sensors 106 using the processors 110. The gaze direction of the subject may be determined according to known methods. As an example, the location of the eyes of the subject may be determined by processing the sensor outputs of the sensors 106 using machine vision techniques, as described with respect to determining the location of the subject with respect to the display device 100. The sensor outputs of the sensors 106, such as images obtained by cameras from the sensors 106, are further processed to determine the angular orientation of the eyes of the subject, using machine vision techniques or other suitable techniques, and the angle at which the subject's eyes are oriented can be estimated based on the angles determined from the images. The gaze angle of the subject may be represented in any suitable form, such as by defining a line in three-dimensional space relative to the location of the flexible display screen 104 of the display device 100, or by defining the gaze angle relative to the location of the subject.

As will be explained further herein, the gaze direction of the subject may be utilized to make determinations, by the processor, in order to control operation of the display device 100. As an example, the processors 110 may be configured to determine, based on the sensor outputs from the sensors 106, whether the gaze direction of the subject is oriented toward the flexible display screen 104 of the display device 100, and control operation of the display device 100 accordingly, such as perming an action or foregoing performance of the action based on the determination.

Operation 463 includes making one or more observations about the environment 101. The observations about the environment 101 may be made using the sensors 106 of the display device 100 and may be processed and interpreted by the processors 110 of the display device 100. Making observations about the environment 101 may include processing inputs from cameras, lidar modules, or other ones of the sensors 106 to identify the presence, type, and location of objects that are within the sensing range of the sensors 106. As an example, the sensors outputs from the sensors 106 may be interpreted by the processors 110 to determine the locations of chairs, tables, and other furniture that may be present in the environment 101. Making observations about the environment 101 may include processing other type of inputs from the sensors and making other types of determinations about conditions in the environment 101.

Operation 464 involves determining whether to move the flexible display screen 104 of the display device 100 between the stored configuration and the deployed configuration. This determination may be made by the processors 110 based on information including the observations of the subject of the display device 100 from operation 462, and observations of the environment 101 from operation 463.

To determine whether to move the flexible display screen 104 between the stored configuration and the deployed configuration, the processors 110 are configured to assess whether one or more transition conditions have been met. The one or more transition conditions may be implemented in the form of computer program instructions that are provided to the processors 110. The one or more transition conditions may include assessment of the observations of the subject, assessment of the observations of the environment 101, and/or assessment of other circumstances. Different transition conditions may be used for determining whether to transition from the stored configuration to the deployed configuration as opposed to determining whether to transition from the deployed configuration to the stored configuration. Thus, for example, a state machine may be defined control transitions between a first state corresponding to the stored configuration, and a second state corresponding to the deployed configuration. A state change may be performed when all conditions from a set of state change conditions are met. In some cases, a set of state change conditions may require that all conditions be met for at least a minimum time period before a transition is performed. There may be multiple independent sets of state change conditions, and satisfaction of any single set of conditions may be sufficient to cause a state change.

The transition conditions may include an assessment based on the location of the subject, inclusive of assessment of a distance of the subject from the flexible display screen 104. As one example, a location-based transition condition for movement from the stored configuration to the deployed configuration may be satisfied when the distance of the subject from the flexible display screen 104 is less than a threshold distance. As another example, a location-based transition condition for movement of the flexible display screen 104 from the deployed configuration to the stored configuration may be satisfied when the distance of the subject from the flexible display screen 104 is greater than a threshold distance.

In some implementations, the transition conditions may assess the location of the subject based on spatial thresholds that are compared to the distance of the subject from the flexible display screen 104 of the display device 100. For example, a first distance range may be defined that is associated with a preference for transitioning the display device 100 from the stored configuration to the deployed configuration. Conversely, a second distance range may be defined such that it corresponds to locations that are further from the display device 100 as comparted to the first distance range, and presence of the subject in the second distance range may be associated with a preference for transitioning the display device 100 from the deployed configuration to the stored configuration. Thus, for example, the location of the subject may include a distance of the subject from the flexible display screen 104, the transition conditions may include a comparison of the distance of the subject from the flexible display screen to the first distance range for a transition from the stored configuration to the deployed configuration, and the transition conditions may include a comparison of the distance of the subject from the flexible display screen to a second distance range for a transition from the deployed configuration to the stored configuration.

As another example, a location based transition condition for movement of the flexible display screen 104 from the stored configuration to the deployed configuration may include determining that the location of the subject is within a predefined zone (e.g., a bounded area) of the environment 101. As another example, a location based transition condition for movement of the flexible display screen 104 from the deployed configuration to the stored configuration may include determining that the location of the subject is not within a predefined zone of the environment 101.

To determine whether the subject is within a predefined zone, the processors 110 may be configured to compare the location of the subject to two or more zones of the environment 101, such as the first zone 118a, the second zone 118b, the third zone 118c, or the fourth zone 118d. The determination as to whether the subject is in one of the zones may be used to determine whether to transition between configuration, such as by making a determination to transition from the stored configuration to the deployed configuration based at least in part on presence of the subject in the first zone 118a, or by making a determination to transition from the deployed configuration to the stored configuration based at least in part on presence of the subject in the second zone 118b.

The transition conditions may include an assessment based on movement of the subject. By determining the location of the subject over time, the processors 110 may determine an amount of movement of the subject, such as by classifying the subject as one of in motion or stationary, or by determining a metric describing motion of the subject (e.g., based on a movement frequency and/or a speed of the subject). The classification of the subject as in motion or stationary, or a metric describing the amount of movement of the subject, may be used as a movement-based transition condition for determining whether to move the flexible display screen 104 between the stored configuration and the deployed configuration. As an example, a set of transition conditions may specify that the subject must be stationary (e.g., moving by less than a threshold amount) prior to movement of the flexible display screen 104 from the stored configuration to the deployed configuration. Other types of movement based transition conditions may be utilized to determine whether to move the flexible display screen 104 between the stored configuration and the deployed configuration.

The transition conditions may include an assessment based on the gaze direction of the subject. As an example, the gaze direction of the subject may indicate that the subject is looking toward the display device 100, the gaze direction of the subject may indicate the subject is not looking toward the display device 100, or the gaze direction of the subject may indicate that the subject is looking toward another object, other than the display device 100.

As an example, a gaze-based transition condition for movement of the flexible display screen 104 from the stored configuration to the deployed configuration may be met when the gaze direction of the subject corresponds to looking toward the display device 100 for a time period that is longer than a threshold time period. As another example, a gaze based transition condition for movement of the flexible display screen 104 from the deployed configuration to the stored configuration may be met when the gaze direction of the subject does not correspond to looking toward the display device 100 for a time period that is longer than a threshold time period.

As another example, a gaze-based transition condition may consider whether the subject is looking at an object other than the display device 100. For instance, a transition condition may specify that the display device 100 should forego a transition from the stored position to the deployed position when the gaze direction of the subject corresponds to looking at a particular type of object, such as a book. This analysis may include identifying the object that the subject is looking at based on the gaze direction of the subject, determining an object type for the object the subject is looking at by classification using machine vision techniques, and determining whether the circumstance of the subject's attention toward the identified object should be utilized as a basis for causing a configuration transition or suppressing a configuration transition of the flexible display screen 104.

As another example, the transition conditions may assess the position of the subject relative to the locations of features in the environment 101, as determined in operation 463. As one example, the transition conditions may consider whether the subject is seated in a chair that faces the display device 100, and this circumstance may be utilized as a condition or factor in determining whether to move the flexible display screen 104 between from the stored configuration to the deployed configuration. As another example, the transition conditions may be configured to forego movement of the flexible display screen 104 from the stored configuration to the deployed configuration upon determining that the subject is seated at a table from which the subject does not typically use the display device 100.

In some implementations, the transition conditions utilized by the processors 110 may include an intention probability score. The intention probability score may be computed by the processors 110 based on the location of the subject, the gaze direction of the subject, and/or other factors. The intention probability score serves as a quantitative measure of the likelihood that the subject wants the flexible display screen 104 to transition between the stored configuration and the deployed configuration. The intention probability score may be determined by assigning a numerical value to each of one or more circumstances. In a simple example of determining whether to transition from the stored configuration to the deployed configuration, a numerical value may be assigned based on the distance between the subject and the display device 100, with lower distances receiving a higher value, and a numerical value may be assigned based on an amount of time over which the gaze direction of the subject has corresponded to looking toward the flexible display screen 104 of the display device 100. These and other numerical values may be combined (e.g., as a sum, weighted sum, or weighted average) and compared to a threshold value, where the transition between configurations is performed if the combined value exceeds the threshold value. These calculations may consider previous subject behavior, such as by applying weighting factors to the components or by modifying the threshold value for transition.

In some implementations, the transition conditions may be evaluated using a trained machine learning model. For example, a machine learning model may be trained using training examples that correlate subject behavior to a presence or absence of intent to transition the display device 100 between the stored configuration and the deployed configuration. The model may receive input information derived from the location of the subject, the gaze direction of the subject, and/or other information (time of day, schedule, historical information, etc.) in determining whether to initiate a transition of the configuration of the display device 100. In one implementation, the transition conditions may include an output from the trained machine learning model that estimates whether the subject intends transition of the flexible display screen 104 between the stored configuration and the deployed configuration based on the location of the subject and the gaze direction of the subject.

In operation 464, upon determining that the one or more transition conditions are satisfied, the process may continue to operation 465 in order to change the configuration of the display device 100. If the transition conditions are not satisfied, the process may return to operation 461 for re-evaluation.

Operation 465 includes transitioning the flexible display screen 104 of the display device 100 between the stored configuration and the deployed configuration. In particular, the processors 110 are configured to control the actuators 108 to move the flexible display screen 104 in response to the determination, in operation 464, that the one or more transition conditions are satisfied. Operation 465 may include transmitting commands from the processors 110 to the actuators 108. The commands may cause the actuators 108 to move the flexible display screen 104 from the stored configuration to the deployed configuration, or the commands may cause the actuators 108 to move the flexible display screen 104 from the deployed configuration to the stored configuration, as appropriate. The process 460 may then return to operation 461 for additional iterations.

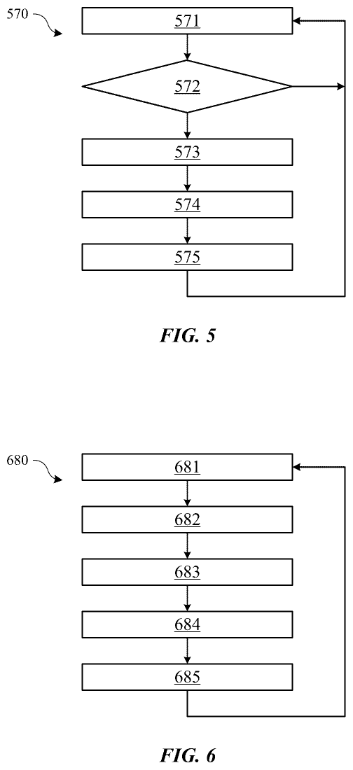

FIG. 5 is a block diagram of a process 570 for controlling operation of a display device to allow a limited display of content on the flexible display screen 104 while the display device is in a stored configuration. The process 570 is described with reference to the display device 100. The process 570 may also be implemented using other types of display devices that are configured to move between stored and deployed configurations, including the display device 200. The process 570 may also be implemented using other types of display devices that are configured to move between stored and deployed configurations. The process 570 may be implemented in the form of computer program instructions that are provided to the processors 110. When executed, the computer program instructions cause the processors 110 to control the display device 100 according to the operations of the process 570, as described herein. The instructions may be obtained by the processors 110 from a non-volatile storage device or may be obtained by the processors 110 in any other suitable manner. Details from the process 350 and the process 460 may be incorporated in or used with the process 570.

The process 570 may be performed repeatedly, on an ongoing basis, in order to allow a content item to be positioned on the flexible display screen 104 dependent on the location of the subject. The process 570 is intended for use when the display device 100 is in the stored configuration. Because of the geometric configuration (e.g., convex curvature) of the flexible display screen 104 when in the stored configuration, the subject may only be able to see a portion of the flexible display screen 104 from some locations, and some portions of the flexible display screen 104 may be unviewable from the location of the subject (e.g., because those portions of the flexible display screen 104 face away from the subject). In the illustrated implementation, the process 570 includes obtaining sensor outputs from the sensors 106 in operation 571, determining whether the subject is present in the environment 101 in operation 572, determining the location of the subject in operation 573, determining a content location in operation 574, and displaying a content item at the content location in operation 575.

The content item displayed in the process 570 is intended for viewing when the display device 100 is in the stored configuration. The content item represents a limited display of content, which may be dissimilar from the types of content presented on the flexible display screen 104 when in the deployed configuration. As one example, the content displayed in the stored configuration may be an informational display, such as a weather interface that shows the expected temperatures, cloud cover, and precipitation in a given area, where the informational display is presented in a manner that allows the subject to perceive the information while they are walking past the display. As another example, the content displayed in the stored configuration may be an avatar (e.g., the face of a character) that represents an automated assistant program that the subject can interact with. The content item may be further distinguished from a full display of content in that it may occupy a limited area of the flexible display screen 104. For instance, in the deployed configuration, flexible display screen 104 may be used to display content that is intended to be displayed using an entirety of the flexible display screen 104. In the stored configuration, the flexible display screen 104 may be controlled by the processors 110 to display the content item such that it occupies a limited portion of the flexible display screen 104, such as twenty-five percent or less, twenty percent or less, fifteen percent or less, or ten percent or less of a spatial area of the flexible display screen 104.

Operation 571 includes obtaining sensor outputs from the sensors 106 in order to allow the processors 110 to make observations about the environment 101 based on the sensor outputs. Operation 571 may be performed in the manner described with respect to operation 461 of the process 460.

Operation 572 includes determining whether the subject is present in the environment 101, and operation 573 includes determining the location of the subject with respect to the display device 100. If no subject is present in operation 572, the process may return to operation 571, and the display device 100 may forego display of content on the flexible display screen 104 (e.g., the flexible display screen 104 may be inactive/turned off) or may display a content item on the flexible display screen 104 at a default position, a random position, or other position determined without reference to subject location. If the subject is present in the environment 101, the process proceeds to operation 573. The determinations of subject presence and location made in operation 572 and operation 573 may be made using the sensor output signals from the sensors 106, such as by processing images obtained using the sensors 106 according to machine vision techniques, or by processing other types of sensor outputs according to suitable techniques. As an example, operation 572 and operation 573 may be implemented in the manner described with respect to making one or more observations about the subject in operation 462 of the process 460.

Operation 574 includes determining a content location at which to display the content item. The processors 110 are configured to determine a content location along the first direction 105a (e.g., the width direction) of the flexible display screen 104 according to the location of the subject relative to the flexible display screen 104, and to display a content item on the flexible display screen 104 according to the content location. The content location is determined such that the content item is viewable from the location of the subject when the content item is displayed according to the content location. In some implementations, the processors 110 and may also use additional information derived from the sensor outputs of the sensors 106 to make this determination.

The content location may be determined in a continuous manner, by calculating a location along the first direction 105a at which to output the content item, setting the content location according to the calculated location, and displaying the content item at the content location, such as by positioning a width-wise center of the content item at the content location. In this implementation, setting the content location according to the calculated location may include rounding or otherwise quantizing the content location, such as by rounding according to a percentage of the first direction 105a or rounding according to a particular number of pixels.

One implementation of calculating the content location in a continuous manner included determining an imaginary line, referred to herein as a reference line. The processors 110 are configured determine a reference line between the subject and the flexible display screen 104, and to determine the content location according to a location of the reference line with respect to the flexible display screen 104. The reference line may be determined by the processors 110, for example, using geometric techniques. As an example, after constructing the reference line, the processors 110 may determine the content location according to the location on the flexible display screen 104 that intersects the reference line, and the content location along the first direction 105a of the flexible display screen 104 may be set based on the location of that point.

The reference line is constructed by the processors 110 such that the reference line extends from the flexible display screen 104 to the location of the subject. The processors 110 may determine the reference line such that the reference line is perpendicular to the flexible display screen 104. As an example, the processors 110 may construct the reference line using geometric techniques, such that the reference line extends between the location of the subject and a reference point relative to the display device 100. As one example, the reference point may be a central point on the base 102 of the display device 100. As another example, the reference point may be a center of bending for the flexible display screen 104 of the display device 100. As another example, the reference point may be a point on the flexible display screen 104 of the display device 100, such as a point on the flexible display screen 104 that is closest to the subject.

The content location may be determined in a discrete manner, by using the location of the subject to select the content location from a group of predefined content locations. As one example, the reference line can be determined, as previously discussed, the processors 110 may identify one of the predetermined content locations based on the reference line, such as by proximity or by intersection of the reference line with one of the predetermined content locations, and the identified one of the predetermined content locations may be used as the content location for output of the content item on the flexible display screen 104.

In another implementation, the processors 110 may be configured to identify the location of the subject relative to the flexible display screen 104 as corresponding to a predefined environment zone, such as the first zone 118a, the second zone 118b, the third zone 118c, or the fourth zone 118d. The processors 110 may then select the content location from the group of predefined content locations based on the predefined environment zone. As an example, each of the predefined content locations may correspond to a respective predefined environment zone.

FIG. 6 is a block diagram of a process 680 for controlling operation of a display device to transition between the stored configuration and the deployed configuration, and to control display of content when in the deployed configuration. The process 680 is described with reference to the display device 100. The process 680 may also be implemented using other types of display devices that are configured to move between stored and deployed configurations, including the display device 200. The process 680 may also be implemented using other types of display devices that are configured to move between stored and deployed configurations. The process 680 may be implemented in the form of computer program instructions that are provided to the processors 110. When executed, the computer program instructions cause the processors 110 to control the display device 100 according to the operations of the process 680, as described herein. The instructions may be obtained by the processors 110 from a non-volatile storage device or may be obtained by the processors 110 in any other suitable manner. Details from the process 350, the process 460, and the process 570 may be incorporated in or used with the process 680.

The process 680 may be performed repeatedly, on an ongoing basis, in order to allow a content item to be positioned on the flexible display screen 104 dependent on the location of the subject. The process 680 is intended for use when the display device 100 is in the stored configuration. Because of the geometric configuration (e.g., convex curvature) of the flexible display screen 104 when in the stored configuration, the subject may only be able to see a portion of the flexible display screen 104 from some locations, and some portions of the flexible display screen 104 may be unviewable from the location of the subject (e.g., because those portions of the flexible display screen 104 face away from the subject). In the illustrated implementation, the process 680 includes obtaining sensor outputs from the sensors 106 in operation 681, determining whether the subject is in proximity of the display device 100 in operation 682, determining whether to transition between the stored configuration and the deployed configuration in operation 683, transitioning between the stored configuration and the deployed configuration in operation 684, and controlling display of content in operation 685. The content item displayed in the process 680 is intended for viewing when the display device 100 is in the deployed configuration. The content item may be a limited display of content, as previously described, or may be a display of content that utilizes all of the area of the flexible display screen 104.

Operation 681 includes obtaining sensor outputs from the sensors 106 in order to allow the processors 110 to make observations about the environment 101 based on the sensor outputs. Operation 681 may be performed in the manner described with respect to operation 461 of the process 460. Operation 681 includes obtaining sensor outputs from a first sensor from the sensors 106 when the display device 100 is both in the stored and deployed configurations. Operation 682 includes obtaining sensor outputs from a second sensor from the sensors 106 only when the display device 100 is in the deployed configuration. The first sensor is a low resolution sensor having a first resolution. The second sensor has a second resolution that is higher than the resolution of the second sensor. As examples, the first sensor may be an infrared sensor, an ultrasonic sensor, a radar sensor, a pulse lidar, or another type of sensor. As examples, the second sensory may be a still camera or a video camera. Other types of sensors or combinations of sensors may be used as the first sensor and the second sensor.

Operation 682 includes determining whether the subject is in proximity of the display device 100 in operation 682. As one example, the subject is in proximity of the display device 100 when it is in sensing range of one or both of the first sensor and the second sensor. As one example, the subject is in proximity of the display device 100 when it is within a threshold distance of the display device 100. The determination of whether the subject is in proximity of the display device 100 may be made using output only from the first sensor in the stored configuration, and without use of output from the second sensor. This may allow, for example, lower power usage in the stored configuration. The determination of whether the subject is in proximity of the display device 100 may be made using output from both of the first sensor and the second sensor in the deployed configuration, or may be made using output only from the second sensor in the deployed configuration.

Operation 683 includes determining whether to transition between the stored configuration and the deployed configuration. In the stored configuration, the processors 110 may determine to transition to the deployed configuration when the subject is sensed in proximity of the display device 100 by the first sensor. In the deployed configuration, the processors 110 may determine to transition to the stored configuration when the subject is not sensed in proximity of the display device 100 by either of the first sensor or the second sensor for a threshold time period (e.g., the subject has not been sensed for 60 seconds). As another example, in the deployed configuration, the processors 110 may determine to transition to the stored configuration when the subject is not sensed in proximity of the display device 100 by only the second sensor for a threshold time period (e.g., the subject has not been sensed for 60 seconds). Operation 684 includes transitioning between the stored configuration and the deployed configuration according to the determination made in operation 683 and may be performed as previously described.

Operation 685 includes controlling display of content based on sensing of the subject by the second sensor from the sensors 106. As one example, the processors 110 may determine a characteristic of the subject, and control display of the content based on the characteristic. As one example, a first type of content item may be displayed when the characteristic is engagement in a first type of activity and a second type of content item may be displayed when the characteristic is engagement in a second type of activity. As another example, the output from the second sensor may be used to determine the identity of the subject and the processors 110 may select the content item based on the identity of the subject, for example, according to a preference or profile associated with the subject. As another example the display of content may be controlled by determining the content location for the content item, for example, based on the location of the subject relative to the flexible display screen 104 in the manner previously described.

In an implementation of the display device 100 that incorporates the process 680, the display device includes the flexible display screen 104 and one or more actuators, such as the actuator 108, which configured to move the flexible display screen 104 between the stored configuration and the deployed configuration. The display device 100 also includes a first sensor from the sensors 106 configured to sense a subject in proximity of the flexible display screen 104, the first sensor having a first resolution, and a second sensor from the sensors 106 configured to sense the subject in proximity of the flexible display screen 104, the second sensor having a second resolution, wherein the second resolution is higher than the first resolution. The display device 100 also includes one or more processors, such as the processors 110, which are configured to control the one or more actuators to move the flexible display screen 104 between the stored configuration and deployed configuration in response to a determination that the subject is sensed by the first sensor, and display a content item based on sensing of the subject by the second sensor. The one or more processors may be further configured to control the one or more actuators to move the flexible display screen 104 between the deployed configuration and stored configuration in response to a determination that the subject has not sensed by the first sensor or by the second sensor for a threshold time period. The first sensor may configured to sense that the subject is in proximity of the flexible display screen 104 when the subject is within a sensing range of the first sensor. The one or more processors may be configured to select the content item based on a characteristic of the subject sensed by the second sensor. The one or more processors may be configured to determine a content location on the flexible display screen 104 based on a location of the subject sensed by the second sensor when the flexible display screen 104 is in the deployed configuration, and to display the content item at the content location.

As described above, one aspect of the present technology is the gathering and use of sensor data to improve the delivery of user interfaces and other information on deployable displays. The present disclosure contemplates the use of sensors ranging from low fidelity sensors such as vacancy and occupancy detectors as well as the higher fidelity sensors such as a RGB image sensors. The use of sensor information, in the present technology, can benefit users. For example, an electronic device can adjust its display mechanism based on the type and level of engagement from its user. At the same time, however, implementors are reminded that the collection, analysis, disclosure, transfer, storage, or other uses of sensor data should comply with well-established privacy policies and/or privacy practices. In particular, such entities would be expected to implement and consistently apply privacy practices that are generally recognized as meeting or exceeding industry or governmental requirements for maintaining the privacy of users.

For example, the present technology can be configured to allow users to select to “opt in” or “opt out” of the use of sensor information and/or what type of sensor information is to be used. Some implementations may use sensors that provide a low level of image resolution such that an object may be detected without capturing details of the object. Some implementations may implement local sensor data processing so that sensor data is utilized and deleted without being transmitted beyond the local device. Some implementations may implement anonymization techniques to remove sensitive aspects of data. It is the intent of the present disclosure that sensor data should be managed and handled in a way to minimize risks of unintentional or unauthorized access or use.

What is claimed is:

1. A display device, comprising:
a flexible display screen; and
one or more actuators configured to induce bending of the flexible display screen in a first direction to move the flexible display screen between a first configuration and a second configuration, wherein the flexible display screen is one of flat or concave in the first direction in the first configuration, and the flexible display screen is convex in the first direction in the second configuration,
wherein the one or more actuators are activatable to move the flexible display screen between the first configuration and the second configuration by one of a sensor output from one or more sensors, a request from a software application, or a command from a subject.

2. The display device of claim 1, wherein the one or more sensors are configured to identify a location of the subject relative to the flexible display screen, the display device further comprising:
one or more processors configured to determine a content location along the first direction of the flexible display screen according to the location of the subject relative to the flexible display screen, and to display a content item on the flexible display screen according to the content location, wherein the content location is determined such that the content item is viewable from the location of the subject when the content item is displayed according to the content location.

3. The display device of claim 2, wherein the one or more processors are further configured to determine a reference line between the subject and the flexible display screen, and to determine the content location according to a location of the reference line with respect to the flexible display screen.

4. The display device of claim 3, wherein the one or more processors are further configured to determine the reference line such that the reference line is perpendicular to the flexible display screen and such that the reference line extends from the flexible display screen to the location of the subject.

5. The display device of claim 2, wherein the one or more processors are further configured to identify the location of the subject relative to the flexible display screen as corresponding to a predefined environment zone, and to select the content location from a group of predefined content locations based on the predefined environment zone.

6. The display device of claim 1, wherein the one or more sensors are connected to the flexible display screen and move with the flexible display screen between the first configuration and the second configuration.

7. The display device of claim 6, wherein the one or more sensors are arranged in an array along a bezel of the flexible display screen and are spaced from one another along the first direction.

8. The display device of claim 7, wherein the flexible display screen has a width defined between a first end and a second end that are spaced from one another in the first direction, and a first pair of the sensors is spaced apart by a distance equal to or greater than twenty-five percent of the width of the flexible display screen.

9. The display device of claim 6, wherein the one or more sensors include one or more cameras, one or more lidar modules, or a combination thereof.

10. The display device of claim 1, wherein the flexible display screen is generally cylindrical in the second configuration.

11. A display device, comprising:
a display screen;
one or more actuators configured to move the display screen between a stored configuration and a deployed configuration;
one or more sensors configured to identify a location of a subject and a gaze direction of the subject relative to the display screen; and
one or more processors configured to determine whether one or more transition conditions are satisfied based on the location of the subject and the gaze direction of the subject, and configured to control the one or more actuators to move the display screen between the stored configuration and deployed configuration in response to a determination that the one or more transition conditions are satisfied.

12. The display device of claim 11, wherein the one or more transition conditions include an intention probability score that is determined based on the location of the subject and the gaze direction of the subject and represents a likelihood that the subject intends transition of the display screen between the stored configuration and the deployed configuration.

13. The display device of claim 11, wherein the one or more transition conditions include an output from a trained machine learning model estimates whether the subject intends transition of the display screen between the stored configuration and the deployed configuration based on the location of the subject and the gaze direction of the subject.

14. The display device of claim 11, wherein the location of the subject includes a distance of the subject from the display screen, the transition conditions include a comparison of the distance of the subject from the display screen to a first distance range for a transition from the stored configuration to the deployed configuration, and the transition conditions include a comparison of the distance of the subject from the display screen to a second distance range for a transition from the deployed configuration to the stored configuration.

15. The display device of claim 11, wherein the one or more sensors are connected to the display screen and move with the display screen between the stored configuration and the deployed configuration.

16. A display device, comprising:
a base structure having an external geometric configuration;
a display screen; and
one or more actuators configured to induce movement of the display screen between a stored configuration and a deployed configuration, wherein the display screen conforms to the external geometric configuration of the base structure when the display screen is in the stored configuration, and at least part of the display screen is spaced from the base structure in the deployed configuration.

17. The display device of claim 16, further comprising:
a fixed display screen that is coupled to the base structure, wherein the display screen and the fixed display screen are controllable to display a continuous image when the display screen is in the stored configuration.

18. The display device of claim 17, wherein the fixed display screen is located on a top surface of the base structure and the display screen is located adjacent to one or more side surfaces of the base structure when the display screen is in the stored configuration.

19. The display device of claim 16, wherein the display screen is flexible, movement of the display screen between the stored configuration and the deployed configuration comprises bending of the display screen, the display screen is convex in the stored configuration, and the display screen is one of flat or concave in the deployed configuration.

20. The display device of claim 16, wherein the display screen includes a first rigid panel and a second rigid panel, movement of the display screen between the stored configuration and the deployed configuration comprises movement of the first rigid panel and the second rigid panel with respect to one another, the first rigid panel and the second rigid panel are oriented at an angle of at least forty-five degrees with respect to each other in the stored configuration, and the first rigid panel and the second rigid panel are aligned with each other in the deployed configuration.
